(19) United States
(12) Patent Application Publication
(10) Pub. No.: US 2019/0258959 A1
(43) Pub. Date: Aug. 22, 2019

(54) REMOTE CONTROL SIGNAL PROCESSING IN REAL-TIME PARTITIONED TIME-SERIES ANALYSIS

(71) Applicant: International Business Machines Corporation, Armonk, NY (US)

(72) Inventors: Bharath Kumar Devaraju, Westmead (AU); Sripriya Srinivasan, San Jose, CA (US)

(21) Appl. No.: 16/401,252

(22) Filed: May 2, 2019

Related U.S. Application Data
(63) Continuation of application No. 15/805,188, filed on Nov. 7, 2017.

(51) Int. Cl. G06N 20/00

(52) U.S. Cl. CPC G06N 20/00

(57) ABSTRACT

Machine logic (for example, software) for automatic detection of a probable error in the output of a stream processing model. The detection of this probable error leads to the taking of a responsive action, which, generally speaking, may be one of two types of responsive action: (i) automatically notifying a human individual of the probable error; and/or (ii) automatically taking corrective action (for example, retraining of the model, automatically switching to a redundant backup sensor) without substantial human intervention. In some cases, the probable error is caused by a faulty sensor, which means that retraining will not fix the detected error. In some cases, the probable error is caused by a new trend in the data, which means that retraining on newer data can fix the detected error.

### BACKGROUND

The present invention relates generally to the field of stream processing, and more particularly to handling sensor malfunctions in stream processing computer system that receive streaming data from multiple sensors.

Stream processing is a computer programming paradigm. It is sometimes also referred to as dataflow programming, event stream processing or reactive programming. Stream processing allows some applications to more easily exploit a limited form of parallel processing. Such applications can use multiple computational units (for example, a floating point unit on a graphics processing unit or field-programmable gate arrays (FPGAs)) without explicitly managing allocation, synchronization, or communication among those units. Stream processing typically simplifies parallel software and hardware by restricting the parallel computation that can be performed. Given a sequence of data (called a “stream”), a series of operations (called “kernel functions”) is applied to each element in the stream. Kernel functions are typically pipelined. Local on-chip memory reuse is typically performed, as appropriate, to minimize the loss in bandwidth. Uniform streaming, where one kernel function is applied to all elements in the stream, is typical. Because the kernel and stream abstractions expose data dependencies, compiler tools can fully automate and optimize on-chip management tasks. Stream processing hardware can use scoreboarding, for example, to initiate a direct memory access (DMA) when dependencies become known. The elimination of manual DMA management reduces software complexity, and an associated elimination for hardware cached I/O, reduces the data area expanse that has to be involved with service by specialized computational units such as arithmetic logic units.

Some known stream processing computer systems use control input ports and supported control signals and parameters as will now be discussed. The control port is an optional input port where control signals can be sent to control the behavior of an operator. The behavior of the operator can be changed at run time without having to recompile the running application. For example, a control signal can be sent to the control port to retrain operators that are not adaptive. If the input data that was used during the learning cycle to estimate the model loses its relevance or the trend of the input data changes significantly, the operator can no longer predict values accurately. A control signal can be sent to the operator and provide sample data for re-estimating the model. The operator can then use this sample data to re-estimate the model to predict values accurately.

Some known control ports support the following control signals:

Retrain: Use new input time series data to rebuild the model. When you retrain a model, the operator takes additional input data and rebuilds the internal mathematical model so that the prediction is more accurate.

Load: Initialize the model with the provided coefficients. If you provide incorrect coefficients, the operator logs a warning message in the log file and continues to predict values by using the older coefficients.

Monitor: Write the coefficients to the optional monitor output port for later use or for further analysis.

Suspend: Stop the training of the model and forecasting of values temporarily. The training of the model and forecasting is suspended until the operator receives the Resume signal.

Resume: Continue with the model training process and forecasting.

Operators and supported control signals will now be discussed. The following list contains the supported control signals for the operators that support the optional input control port:

ARIMA: Supported control signals: Retrain, Monitor, Load, Suspend, and Resume

AutoForecaster: Supported control signals: Retrain, Suspend, and Resume

HoltWinters: Supported control signals: Retrain, Monitor, Load, Suspend, and

Resume

LPC (linear predictive coding): Supported control signals: Retrain, Monitor, Load, Suspend, and Resume

VAR: Supported control signals: Retrain, Monitor, Load, Suspend, and Resume

DSPFilter: Supported control signals: Monitor and Load

Control port parameters will now be discussed. The following optional parameters represent the attributes that contain the control signal and the parameters for the control port:

controlSignal: This optional parameter is an attribute expression that specifies the name of the attribute in the control port, which holds the control signal. The supported type is TSSignal.

partitionBy: This optional parameter is an attribute expression that specifies the name of the attribute in the control port, which the operator uses for retraining, loading, and monitoring a model. If the operator uses the partitionBy parameter, you must also specify the key value to identify the model that one wants to retrain, monitor, or load.

inputCoefficient: This optional parameter is an attribute expression that specifies the name of the attribute in the control port, which ingests the coefficients that are used for loading the model. If this parameter is not specified, by default, the inputCoefficient attribute is used. If the default attribute or the inputCoefficient parameter is not provided, the operator throws an exception. If the attribute or the parameter value does not contain valid coefficients, the load operation fails and the operator logs a warning message for each failed operation. The operator continues to predict values by using the older coefficients. The supported type is map<rstring,map<uint32,float64>>. The following list contains the format for specifying the coefficients:

ARIMA: Format: {“AR”:{0u:{0u:1.1,1u:1.2},1u:{0u:1.2,1u:1.3}},“MA”:{0u:{0u:1.1,1u:1.2}}

Holtwinters: Format: {“Alpha”:{0u:0.5,1u:1.3},“Beta”:{0u:0.5,1u:1.3},“Gamma”:{0u:0.5,1u:1.3}}

LPC: Format: {{0u:{0u:1.1,1u:1.2},1u:{0u:1.2,1u:1.3}}

VAR: Format: {{0u:{0u:[1.1,1.2], 1u:[1.2,1.3]}, 1u:{0u:[1.1,1.2], 1u:[1.1,1.2]}} . . . }

DSPFilter: Format: {“xcoeff”:{0u:1.1,1u:1.2},“ycoef”:{0u:1.2,1u:1.3}}

### SUMMARY

According to an aspect of the present invention, there is a method, computer program product and/or system that performs the following operations (not necessarily in the following order): (i) receiving, by a stream processing computer, from a first sensor and over a communication network, first sensor input data; (ii) applying, by the stream processing computer, the first sensor input data to a first stream processing model included in the streams processing computer to obtain first output data; and (iii) determining, by machine logic of the stream processing computer, that the first output data is anomalous.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram view of a second embodiment of a system according to the present invention;

FIG. 6 is a screenshot view generated by the second embodiment system; and

FIG. 7 is a screenshot view generated by an embodiment of the present invention.

### DETAILED DESCRIPTION

Some embodiments of the present invention are directed to automatic detection of a probable error in the output of a stream processing model. The detection of this probable error leads to the taking of a responsive action, which, generally speaking, may be one of two types of responsive action: (i) automatically notifying a human individual of the probable error; and/or (ii) automatically taking corrective action (for example, retraining of the model, automatically switching to a redundant backup sensor) without substantial human intervention. In some cases, the error is caused by a faulty sensor, which means that retraining will not fix the detected error. In some cases, the error is caused by a new trend in the data, which means that retraining on newer data can fix the detected error.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

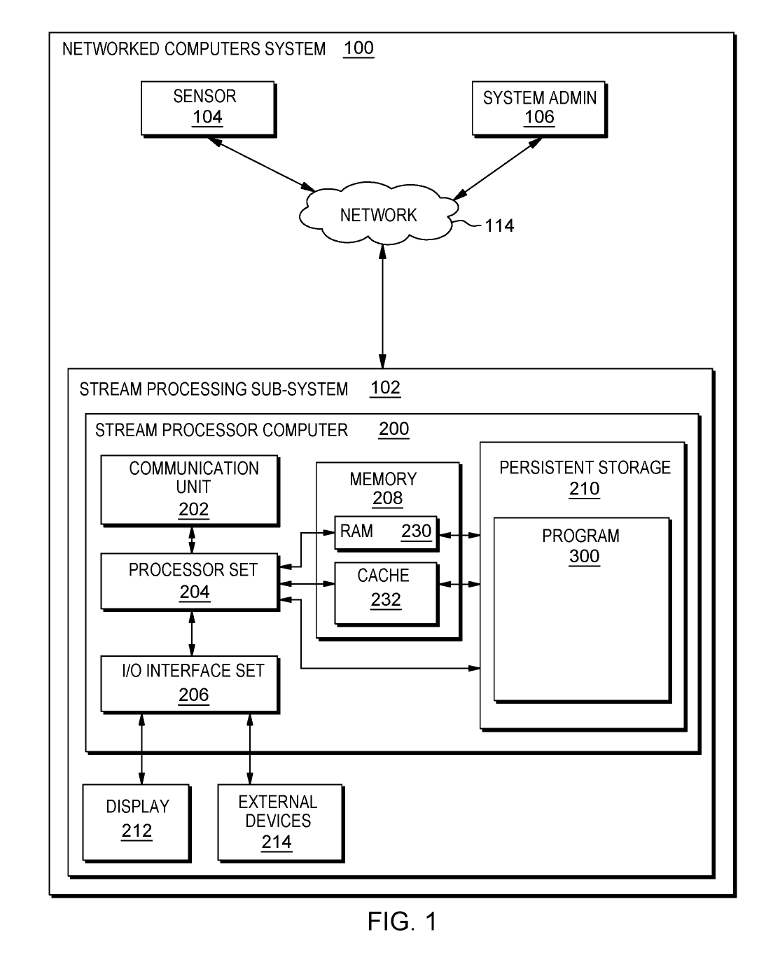

An embodiment of a possible hardware and software environment for software and/or methods according to the present invention will now be described in detail with reference to the Figures. FIG. 1 is a functional block diagram illustrating various portions of networked computers system 100, including: stream processing sub-system 102; sensor 104; system administrator mobile device 106; communication network 114; stream processing computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

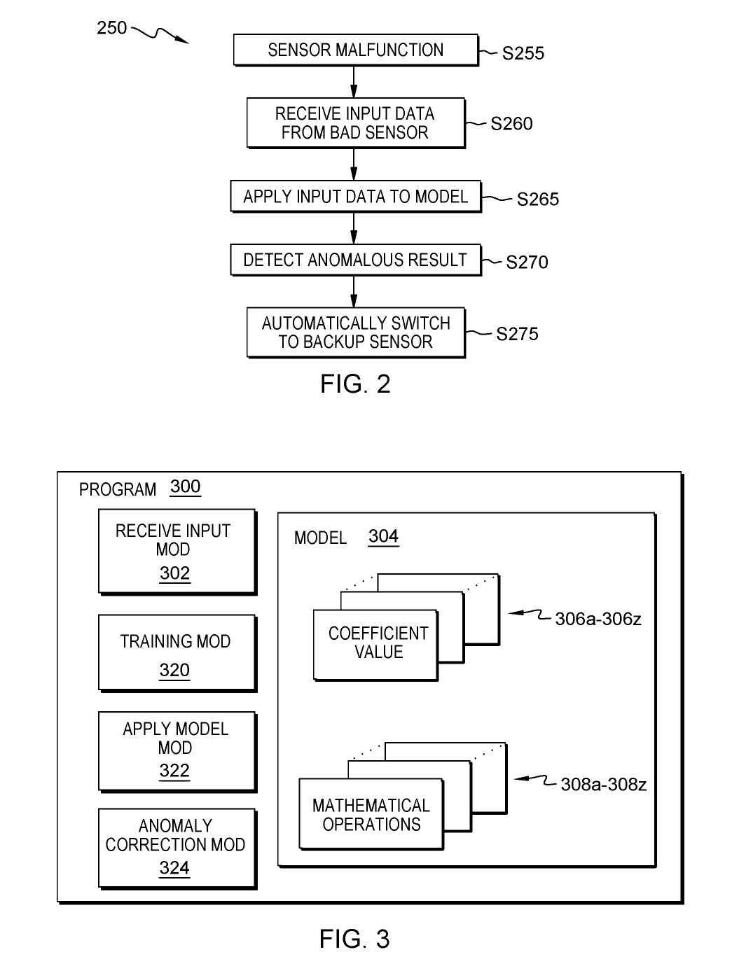

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where sensor 104 (see FIG. 1) malfunctions. In this example, sensor 104 is an ambient light sensor. In this example, system 100 is used to control the operation of airport lights, so it is important to detect and correct this malfunction quickly.

Processing proceeds to operation S260, where receive input mod 302 of program 300 receives incorrect sensor input data from sensor 104 through communication network 114.

Processing proceeds to operation S265, where the incorrect input data is applied by apply model mod 322 to streams processing model 304. As shown in FIG. 3, model 304 is a set of mathematical expression(s) that is used to convert the sensor input data into output data (for an example, a decision about whether to make the airport lights brighter). The expressions of the model rely on: (i) a choice of mathematical operations 308a to 308z to include in the mathematical expressions; and (ii) a determination of coefficient values 306a to 306z to include in the mathematical expressions. As will be understood by those of skill in the art, the foregoing choices and determinations are made by a process called “training the model” (which can be performed by computer code of training mod 320). At the time of operation S265, the model has been trained and there is nothing wrong with the model in this example. However, because the input data from the sensor is incorrect, the application of the mathematical expression(s) of model 304 will lead to anomalous streams processing output data. In this example, that means an anomalous determination of how bright to run the airport lights, which could potentially result in negative consequences.

Processing proceeds to operation S270, where anomaly correction mod 324 detects that the output data is anomalous. As will be discussed in more detail in the following sub-section of this document, this determination may include a determination that the output value is above or below threshold. There may be other types of detectable anomalies (for example, sensor data received too infrequently, output data fluctuating too quickly, etc.).

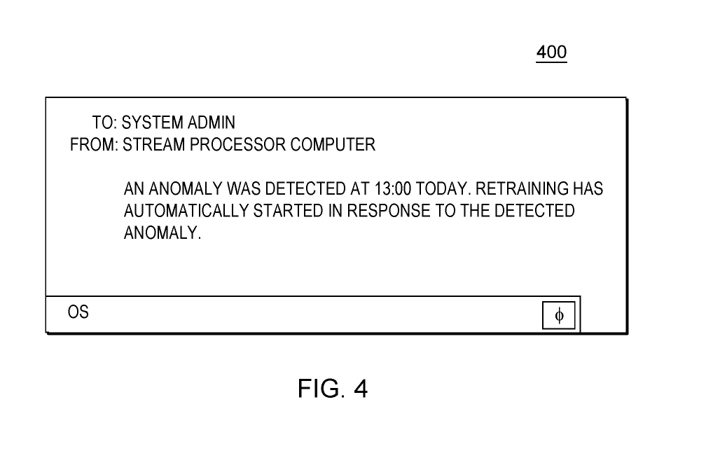

Processing proceeds to operation S275, where anomaly correction mod 324 automatically switches to a backup sensor as a response to the detection of the anomalous result. This responsive action is an automatic responsive action taken by the stream processing sub-system without substantial human intervention. Another possible type of responsive action is automatic retraining of model 304 by training mod 320. Alternatively or additionally, the responsive action could include notification of system administrator 106 (see FIG. 1) or other human individual for example, by email, chat message, pop-up window, etc.). This is shown in screenshot 400 of FIG. 4. This type of responsive action will be discussed, below, in the following sub-section of this document.

### III. FURTHER COMMENTS AND/OR EMBODIMENTS

Some embodiments of the present invention may recognize one, or more, of the following problems, shortcomings, opportunities for improvement and/or facts with respect to the current state of the art: (i) currently there is not believed to be any mechanism to remote monitor and control massively parallel real-time machine learning applications; and/or (ii) for cases which requires human intervention, analysis of a problem and a decision on a course of corrective action cannot be easily automated.

Some embodiments of the present invention may include one, or more, of the following features, characteristics, operations and/or advantages: (i) detection of noise in a partitioned time-series analysis; (ii) performance of detection of noise in a partitioned time-series analysis in real-time; (iii) notification of users of possible course(s) of corrective action; and (iv) execution of a corrective action(s) (also called “execution of the decision”) without affecting parallel models.

Some embodiments of the present invention may include one, or more, of the following features, characteristics, operations and/or advantages: (i) real-time decision making by users when an anomaly is detected; (ii) users need not be constantly monitoring the system, thereby giving users the flexibility to stay informed of the status and act on it remotely; (iii) increases robustness of the entire solution since other models in the solution are not affected only affected models are actioned; (iv) the affected model is prevented from further corruption since anomalies are acted upon in real-time; (v) in a portioned time-series several independent sources are analyzed in parallel by the same real-time machine learning system; and/or (vi) unlike traditional approach of creating failure patterns or pattern matching, some embodiments of the present invention can be applied for Bigdata real-time solutions that are characterized by a large number and variety of sources ingesting the data.

An embodiment will now be discussed as an example. While analyzing weather patterns, a single machine learning operator is fed values from different sources. These values tagged by identification codes that identify the respective sources of the values. More specifically, in this example, temperature readings from various cities tagged by their name as follows:

&Sydney8, 30,1-1-2017 10:00

&New York8,2, 1-1-2017 10:00

In this example, the sensor related to Sydney malfunctions. This causes the error in predictions to increase. In this example, prediction errors are calculated using several algorithms, including some algorithms based on RMS (root mean square error) mathematics. When the error crosses a threshold, this is taken to signify an anomaly. In response to this detection of an anomaly, end users are notified of the detected anomaly using a mobile interface that uses messaging protocols like XMPP (Extensible Messaging and Presence Protocol). The XMPP adapters in the streams solution broadcast the anomaly payload. The payload includes snapshot of coefficients, amount of error (RMS value), partition name (Sydney), and possible responsive actions (Pause, Retrain, Continue). In this example, the XMPP packet is received by the mobile device and end users are thereby notified. End users can analyze the model coefficients and error factor. Based upon this analysis, end users decide which action to apply.

Some embodiments of the present invention may include one, or more, of the following features, characteristics, operations and/or advantages: (i) streams application running analytics on big data scale and listening to user commands; (ii) user mobile application listens to notifications from streams job and then replies back to streams application; (iii) uses a streams solution including a series of interconnected operators which analyze the data in real-time. Following is an example real-time application flow; (iv) streams provides machine learning operators like HoltWinters and/or ARIMA; (v) the machine learning operators learn from input data and predict the future values; (vi) learning involves estimating values for co-efficient (x and y) and prediction involves applying the co-efficient on input data to generate future values; (vii) the machine learning operators have the ability to process inputs from different sources in parallel tagged by partition id (identification code); (viii) the machine learning operators also have the ability to receive control signals by a port to control the behavior in real time; (ix) applications where millions of sensors are analyzed in parallel; and/or (x) if one of the sensors goes faulty, recognition of the anomaly and taking of appropriate responsive action without affecting other models running in parallel.

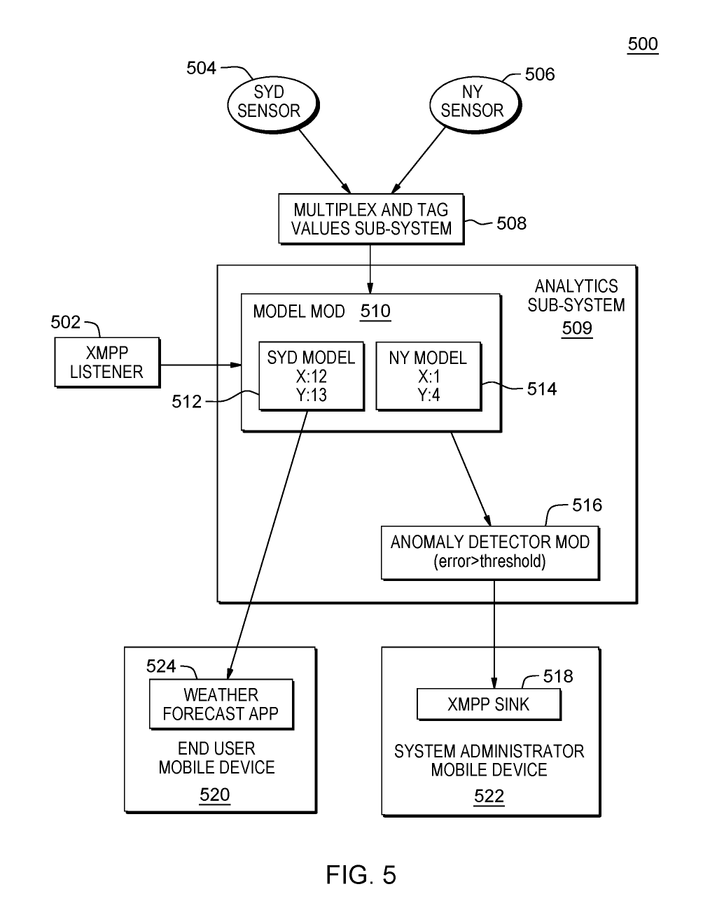

As shown in FIG. 5, temperature prediction system includes: XMPP listener 502; Sydney sensor 504; New York City sensor 506; multiplex and tag values sub-system 508; analytics sub-system 509; end user mobile device 520 (including weather forecast app 524); and system administrator mobile device 522 (including XMPP sink 518. Analytics sub-system 509 includes model module (“mod”) 510; and anomaly detector mod 516. Model mod 510 includes: Sydney model 512 and New York City model 514.

An example of solution flow (that is, communication and processing of data in system 500) will now be discussed in the following paragraphs.

Sydney sensor 504 detects a temperature reading of 30 degrees and sends this information to multiplex and tag values sub-system 508. New York City sensor 506 detects a temperature reading of 10 degrees and sends this information to multiplex and tag values sub-system 508. Multiplex and tag values sub-system 508: (i) tags the 30 degree value received from the Sydney sensor with the tag “SYD”; (ii) tags the 10 degree value received from the Sydney sensor with the tag “NY”; (iii) multiplexes these two tagged values into a single time ordered data stream (that is, data indicating as follows: “SYD”, 30; “NY”, 10); and (iv) sends this time ordered data stream to model mod 510 of analytics sub-system 509. Model mod 510 also receives a control signal from XMPP listener 502.

Model mod 510 includes two “models.” Each “model: is a set of software, hardware, data and/or firmware for processing data according to machine logic rules that evolve over time by programmer adjustments and/or machine learning. Sydney model 512 is structured and programmed to predict future temperatures in Sydney, Australia based upon inputs such as the current temperature in Sydney received from multiplex and tag values sub-system 508 and other analytics-relevant input data (as will be understood by those of skill in the art). New York City model 514 is structured and programmed to predict future temperatures in New York City based upon inputs such as the current temperature in New York City received from multiplex and tag values sub-system 508 and other analytics-relevant input data (as will be understood by those of skill in the art). In this example: (i) Sydney model 512 generates the following output values: Sydney predicted temperature value=12 degrees and Sydney residual error=13 degrees; and (ii) New York City model 514 generates the following output values: New York City predicted temperature value=1 degree and New York City residual error value=4 degrees. As is currently conventional, the predicted temperature values are sent to weather forecast apps of various end users, such as weather forecast app 524 of end user mobile device 520.

The predicted temperature and residual error values are also output to anomaly detector mod 516. Anomaly detector mod 516 determines whether either of the residual error values exceed a threshold. In this embodiment, this threshold is a constant value that is the same for both Sydney residual errors and New York City residual errors. Alternatively, these threshold values may vary depending upon which city the residual error comes from, the absolute value of the predicted temperatures and so on. In this example: (i) the residual error for New York City (that is, 4 degrees) does not exceed the threshold; and (ii) the residual error for Sydney (that is, 13 degrees) does exceed the threshold.

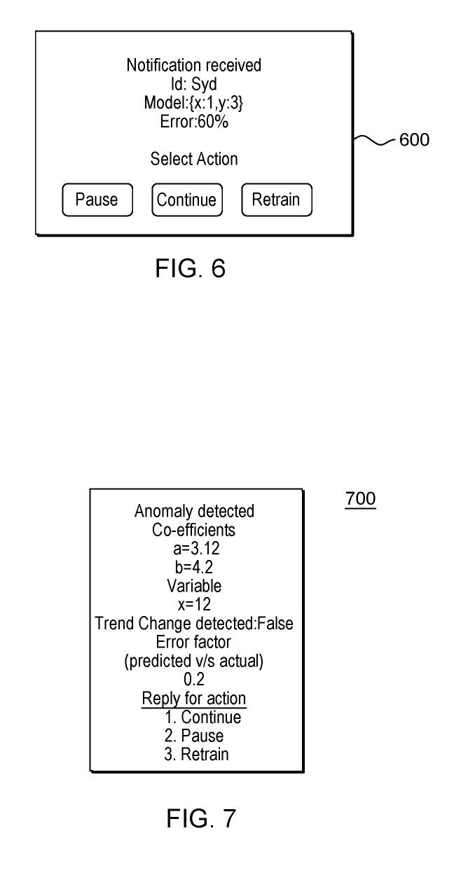

Responsive to the determination that the Sydney residual error exceeds the applicable threshold, anomaly detector module notifies XMPP sink 518 of system administrator mobile device 522 with the following information: (i) model snapshot of the Sydney model; (ii) identification of partition (in this case, Sydney); (iii) suggested responsive action; and (iv) error factor. Screenshot 600 of FIG. 6 shows an example display that is displayed on system administrator mobile device 522 to the system administrator.

Some additional comments regarding the embodiment of system 500 will now be set forth: (i) inputs are tagged and then ingested to machine learning operator; (ii) the machine learning operator processes each tagged source independently a separate model is created and applied; (iii) these operators generate two outputs the prediction values and associated residuals or error; (iv) the error is fed into anomaly detector which checks if it exceeds a certain threshold; (v) if the threshold is exceeded a notification is sent out to end user; (vi) the notification is sent using messaging protocols like XMPP the payload includes all the relevant information for the area specialist to take decisions; (vii) in this example, the relevant information includes: (a) snapshot of the model coefficients, (b) error factor, (c) partition id and (d) suggested actions (pause, continue or retrain); (viii) example payload: Model: {x:1,y:2}, error:40%,id:8syd8,actions:{pause,continue,retrain}; (ix) the system administrator analyzes the data and selects appropriate action which is received by XMPP listener; (x) the XMPP Listener translates user action to operator control signal; (xi) the operator control signal which is injected to specific partition only and does not affect other models running in same operator (that is model mod 510); and (xii) an example control signal code is as follows: {stop: &syd8}. In this way, system 500 provides real-time error detection and notification.

Some features, characteristics, advantages and/or operations of a “mobile application” residing on system administrator sub-system 522 will now be set forth: (i) mobile application is listening to notifications from streams job; (ii) when the notification is received subject matter expert (in this example, the system administrator) looks at it and decides upon a responsive action to take; (iii) some examples of possible responsive actions are: (a) pause the particular model so that it can be inspected later; (b) continue to learn and predict using the model, or (c) retrain or restart the model because the data trend has changed; and (iv) the notification sent by user is consumed by streams job and submitted to the respective operator as shown in FIG. 5.

Commercially available real-time analytical platforms allow users to build jobs or applications to handle or analyze real-time data at a “big data” scale, as will be appreciated by those of skill in the art. These real-time analytical platforms typically provide a plethora of adapters to read and write real time data from various sources and sinks. For example, TCPSource operator reads data from any TCP (transmission control protocol) sockets similarly to File Source. These real-time analytical platforms are typically used in several real life time critical applications. Some of them are anomaly detection, and fraud detection which combines several machine learning algorithms with statistical techniques. In a multivariate system, several independent sources are analyzed in parallel by the same real-time machine learning system. For example, while analyzing weather patterns, a single machine learning operator can be fed values from different sources tagged by their ids. Following is an example of temperature readings from various cities tagged by their name: “Sydney”, 30; “New York”, 2. Individual machine learning models will be created for respective ids and analyzed within the same operator. This is called partitioning.

When there are multiple sources being analyzed, chances are noise may be introduced to the system due to faulty sensor, software bugs or the like. This noise, if allowed over time, will result in model learning from incorrect data and can negatively impact the accuracy of model. Some embodiments of the present invention recognize that there is a need for a mechanism to alert users in real-time of the anomaly along with the evidence to allow users (such as system administrators) to select from a choice of action. A mechanism to detect the anomaly in multivariate system to prevent the corruption of model and in real-time enable users to remotely analyze and act on it without affecting other models running simultaneously. In a Bigdata solution, given the high number of sources, it is difficult to build failure patterns for all. Hence, pre-processing of patterns is not possible.

Some embodiments of the present invention may include one, or more, of the following features, characteristics, operations and/or advantages: (i) detecting noise/anomaly in the multivariate prediction models in real-time and notify the users of possible course of action and execute the decision without affecting parallel running models; (ii) allows real-time decision making by users when an anomaly is detected; (iii) users are not expected to build failure patterns for sources beforehand, instead post processing of anomaly is performed which is ideal for large scale big data solutions; (iv) users need not be monitoring the system always giving them the flexibility to stay informed of the status and act on it remotely; (v) increases robustness of the entire solution because other models in the solution are not affected and only affected models are actioned; (vi) the affected model is prevented from further corruption because anomalies are acted upon in real-time; (vii) in a multivariate system several independent sources are analyzed in parallel by the same real time machine learning system; (viii) the time to implement the solution is reduced given that users are not expected to create failure patterns beforehand; (ix) streams application running analytics on big data scale and listening to user commands; and/or (x) user mobile application which listens to notifications from streams job and then broadcasts back to streams application.

Some embodiments of the present invention may include one, or more, of the following features, characteristics, operations and/or advantages: (i) anomaly in the real time multivariate analytics solution is detected automatically and notification is broadcasted to users mobile; (ii) the payload has the snapshot of the model, error factor and id of source for subject matter expert to analyze and act; (iii) the user's remote application is always listening to notifications from streaming solution, user can analyze the data and select the desired action which includes: (a) “pause” the running of model and diagnose if the source has become faulty, (b) if everything is fine and the anomaly was a minor blip “continue” running the model, or (c) “restart/retrain” the model if the trend of the source has changed; (iv) the streams solution is listening to signals from the user app and user signals are translated to control signals which is injected to machine learning operator on specific partitions only; and/or (v) other models running in parallel are not affected by the action.

Some embodiments of the present invention may include one, or more, of the following features, characteristics, operations and/or advantages: (i) real time processing of anomaly detected in a massively parallel machine learning model for robustness; (ii) facilitates and allows plugin any of the proven anomaly detection technique(s); (iii) once anomaly is detected in a one of the parallel models it can be acted upon using methodology(ies) described above); (iv) resilience of partitioned time-series prediction models which is running in parallel and when an anomaly is detected by any of the available techniques plugged in; (v) when an anomaly is detected the respective SME reviews the snapshot of prediction model along with anomaly and executes the action by ingesting control signals to running model; (vi) control signals provide the ability to control the behavior of specific model without affecting parallel models increasing overall robustness of solution; and/or (vii) given the large number and expansive variety of sources ingesting data in real-time Bigdata machine learning, some embodiments can can decrease chances of false positives.

Some embodiments of the present invention may include one, or more, of the following features, characteristics, operations and/or advantages: (i) deals with resilience or robustness of realtime machine learning solution by doing following; (ii) allow users to plug in any anomaly detection logic; (iii) when anomaly is detected in the output (for example, deviation in predicted value from actual), users are notified with 3 possible course of action to prevent model corruption, which are: (a) continue: ignore as false alarm, (b) retrain the model—there is change in trend, and (c) pause—to investigate; (iv) the problem/use-case for the machine learning solution is of little concern in some embodiments; (v) applicable to any ML model which learns and adapts in realtime; (vi) techniques to prevent model from going bad or producing incorrect results; and/or (vii) the models each take the form of an in memory representation of coefficients and variables. As an example of item (v) in the foregoing list, consider the following equation: ax2+b. Here a and b are coefficients which are estimated and then applied to variable x. In this example, a model corresponding to this simple equation includes a data structure which stores a and b together. Following is a snapshot of how the data structure may look: a=3.12; b=4.2.

As shown in FIG. 7, screenshot 700 includes snapshot of a model as it is presented to a user incident to an anomaly notification. Some embodiments of the present invention operate in real-time such that the latency between occurrence of an anomaly caused by a sensor malfunction and the notification to administrators is less than one second (for example, on the order of milliseconds). In some embodiments, the number of readings per millisecond depends upon several factors such as speed of the sensors and other input devices, the purpose of the processing and so on.

Some embodiments of the present invention may include one, or more, of the following features, characteristics, operations and/or advantages: (i) extensibility or customization of anomaly module apart of the ability to configure the parameters (that is, the thresholds); and (ii) includes a streams processing platform, which allows users to: (a) rapidly build custom operators which can include any anomaly detection logic, and (b) plug in the customer operators to an existing real-time solution.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
receiving, by a stream processing computer, from a first sensor and over a communication network, first sensor input data;
applying, by the stream processing computer, the first sensor input data to a first stream processing model included in the streams processing computer to obtain first output data; and
determining, by machine logic of the stream processing computer, that the first output data is anomalous.

2. The computer-implemented method of claim 1 further comprising:
responsive to the determination that the first output data is anomalous, sending a notification to a device of a human individual.

3. The computer-implemented method of claim 2 wherein the notification includes a user input portion that allows the human individual to choose between at least the following options: continue, retrain and pause.

4. The computer-implemented method of claim 1 wherein:
the streams process processing computer further includes a second stream processing model that receives second sensor input data from a second sensor; and
the determination that the first output data is anomalous does not result in interruption and/or retraining of the second stream processing model.

5. The computer-implemented method of claim 1 further comprising:
subsequent to the determination that the first output data is anomalous, receiving, by the first model of the stream processing computer system, from a listener module and over a communication network, a first control signal; and
responsive to the first control signal, pausing operation of the first model.

6. The computer-implemented method of claim 1 further comprising:
subsequent to the determination that the first output data is anomalous, receiving, by the first model of the stream processing computer system, from a listener module and over a communication network, a first control signal; and
responsive to the first control signal, retraining the first model.
